(19) United States
(12) Patent Application Publication
(10) Pub. No.: US 2011/0027543 A1
(43) Pub. Date: Feb. 3, 2011

(54) POLYURETHANE RESINS FOR LAMINATING INKS

(75) Inventor: Dharakumar Metla, North Wales, PA (US)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Dusseldorf (DE)

(21) Appl. No.: 12/739,625

(22) PCT Filed: Oct. 14, 2008
(86) PCT No.: PCT/EP2008/008672

§ 371 Date: Oct. 19, 2010

Related U.S. Application Data
(60) Provisional application No. 60/981,891, filed on Oct. 23, 2007.

(51) Int. Cl. B32B 3/10; C09D 11/10

(52) U.S. Cl. 428/195.1; 524/590

(57) ABSTRACT

A polyurethane resin which is particularly suitable for use in printing inks for laminating packaging applications is described. The polyurethane resin maintains its lamination bond strength before and after the laminate printed with the ink containing the polyurethane resin is subjected to sterilization conditions. Laminates which maintain a printed image and their structural integrity after sterilization are also described.

### CROSS REFERENCE TO RELATED APPLICATIONS

This application is the National Phase entry of PCT/EP2008/008672, filed Oct. 14, 2008, which claims priority to U.S. provisional patent application No. 60/981,891 filed Oct. 23, 2007, which are incorporated herein by reference in their entireties.

### FIELD OF THE INVENTION

The invention relates to a special polyurethane resin maintaining the bond strength of printed and laminated packaging films before and after sterilization (“retort”), when used alone—preferred—or in combination with other suitable binder resins as film-forming backbone for corresponding solvent-based flexo or gravure inks employed for printing the laminate structures.

### BACKGROUND OF THE INVENTION

Recent diversification in package bags or containers has required a high degree of performance for printing inks or coating agents used for the ornamentation or surface protection thereof. Such inks or coating agents should exhibit excellent adhesiveness for various kinds of plastic films, blocking resistance, and resistance to pasteurization and sterilization conditions.

For instance, printing inks for plastic films are needed to provide better printability, adhesion to a wider range of films, and better blocking resistance and gloss than conventional ones.

Especially, in the field of food packaging, bags or containers made of laminated film materials are used for the reasons that they are sanitary and their contents do not come in direct contact with the ink, and to provide a satisfactory appearance as a high grade of printed products.

Generally there are two methods for producing such laminated film materials. One is an extrusion laminating method, wherein a plastic film substrate is printed with an ink, and if necessary, a primer is applied onto the inked surface; then a molten resin such as polyolefin is extruded onto the inked surface. Another method is an adhesive laminating method, wherein an adhesive is applied onto the inked surface of the plastic film substrate, and a plastic film is then laminated onto the same surface. Accordingly, the laminating inks must possess excellent adhesion to the printing substrate as well as to the film to be laminated.

To preserve the integrity of filling goods—particularly foodstuff—for an extended period time against microbial attack and therefore against premature decomposition when stored on supermarket shelves for example the packaged filling goods are often sterilized directly after packaging to destroy all traces of microorganisms of any kind, that are potential sources for significant shelf life reduction. The term sterilization in the following comprises state-of-the-art techniques like dry heat sterilization, steam sterilization and immersion in boiling water. Since only one printed packaging film is usually not sufficient to ensure a proper sealability and to provide the required barrier properties for water vapour or oxygen for example, laminates are commonly used, where two or more films are glued together by suitable adhesives combining the required performance properties. The ink film necessary for decoration and information purposes is printed onto the inner side of one of the films of the laminate structure, so that it has no direct contact with the filling goods. After printing this printed film is laminated with an adhesive against another non-printed film or against a non-printed laminate structure consisting of more than one film.

When the laminated film materials further undergo sterilization treatment such film laminates should not undergo delamination through the sterilization treatment. Most of these performance requirements for the printing ink or coating mainly depend upon the performance of the binder resin used. Accordingly, in the case of printing inks for plastic films, one or more of various binder resins are selected so as to meet the performance required for individual printing inks. Various polymers have been utilized in printing ink formulations, e.g., polyamides, cellulosics, acrylic and methacrylic esters, ketones, polyvinyl chloride (PVC), polyesters and polyvinyl butyral (PVB). However inconsistencies in adhesion properties to different substrates, selective solubility (either in alcohol or ester), incompatibility with coresins and poor lamination bond strengths have limited the use of these polymers.

Existing commercial polyurethane resins are useful in liquid inks lamination packaging applications. These polyurethane resins show good adhesion to numerous substrates, especially plastic films such as polyethylene terephthalate (PET) or polypropylene (PP). Existing polyurethane resins are also soluble in typical ink solvents, such as alcohol, ester and alcohol/ester blends, for use in flexo and gravure printing applications.

However, such resins possess poor sterilization properties.

Existing commercial polyurethanes exhibit a strong decrease of lamination bond strength after the sterilization process of more than 50%, that is not acceptable for packaging converters posing considerable risks like leakage, that is in contradiction to the required barrier properties for gases and microorganisms, or even mechanical failure with separation of the individual films of the laminate structure during transport or handling.

It is an object of the present invention to provide a polyurethane resin that maintains a high lamination bond strength before as well as after sterilization processing, which resin still maintains solubility in alcohol, ester and alcohol/ester blends, adhesion to high barrier (typically silicon dioxide/aluminum oxide coated) substrates, good pigment grinding, and stable rheology.

### DETAILED DESCRIPTION OF PREFERRED EMBODIMENTS

By way of the invention, a polyurethane resin for use in an ink composition for laminate packaging applications is provided, which polyurethane resin advantageously maintains its high lamination bond strength before and after being subjected to sterilization conditions.

An aspect of the invention then is a polyurethane resin which comprises the reaction product of a polyisocyanate and a polyalcohol to form an isocyanate-terminated prepolymer, which prepolymer is extended with a diamine to form the polyurethane resin of the invention. The resin of the invention substantially maintains its high lamination bond strength before and after sterilization.

The polyurethane resin of the invention possesses at least the same high lamination bond strength before and after sterilization processing, while also maintaining solubility in alcohol, ester and alcohol/ester blends, adhesion to high barrier (typically silicon dioxide/aluminum oxide coated) substrates, good pigment grinding, and stable rheology.

Another aspect of the invention is a printing ink composition suitable for laminating applications containing the polyurethane resin, a colorant, and an organic solvent, which ink composition is suitable for flexo or gravure packaging applications, particularly those packaging applications which are subjected to sterilization conditions.

Accordingly, another aspect of the present invention is a laminate having one surface printed with the ink composition of the invention, wherein the printed image remains substantially unchanged and the laminate remains free of delamination-related defects, after the laminate is subjected to sterilization conditions, due to the presence of the polyurethane resin of the invention in the ink composition.

In a first aspect the present invention relates to the use of a polyurethane resin as binder for a laminating ink for laminated packaging applications, which resin comprises the reaction product of a diisocyanate and a polyalcohol to form an isocyanate-terminated prepolymer, which prepolymer is extended with a diamine to form the polyurethane resin, said polyurethane resin having at least the same high lamination bond strength before and after sterilization with the proviso that if sterilization is done under the conditions 121° C./30 minutes/1.03 bar saturated water steam pressure then the lamination bond strength of the polyurethane before and after sterilization is at least 0.5 N/15 mm peeled at 300 mm/min wherein the lamination bond strength is measured with a dry ink film thickness in the range of 1 to 5 micrometers.

In a preferred embodiment the present invention relates to the use of a polyurethane resin as binder for a laminating ink for laminated packaging applications, which resin comprises the reaction product of a diisocyanate and a polyalcohol to form an isocyanate-terminated prepolymer, which prepolymer is extended with a diamine to form the polyurethane resin, said polyurethane resin having at least the same high lamination bond strength before and after sterilization with the proviso that if sterilization is done under the conditions 121° C./30 minutes/1.03 bar saturated water steam pressure then the lamination bond strength of the polyurethane before and after sterilization is at least 1.2 N/15 mm (which corresponds to 200 g/inch) peeled at 300 mm/min wherein the lamination bond strength is measured with a dry ink film thickness in the range of 1 to 5 micrometers.

Polyurethane resins are described herein which are useful as binders in formulating printing inks for packaging applications, in preparing laminates, which laminates maintain their printed ink images and structural integrity after being subjected to sterilization conditions.

The polyurethane resin of the invention is soluble in an organic solvent, such as alcohol, ester and alcohol/ester blends, and is particularly useful in formulating packaging laminating inks. The resins solubility in alcohol, ester and alcohol/ester blends allows for the formulation of ink or coating compositions for flexo and gravure applications.

Laminating ink and coating compositions formed with the polyurethane resin of the invention exhibit excellent extrusion bond strengths, block resistance, printability, resolubility, sterilization resistance, and superior adhesion on a wide variety of films, as compared to laminating inks and coatings made with conventional and commercially available polyurethane resin binder systems. Particularly, the ink compositions containing the polyurethane resin of the invention are especially suitable for packaging applications wherein laminates printed with the ink compositions undergo sterilization treatment.

The polyurethane resin is prepared by reacting an aliphatic, cycloaliphatic, aromatic or alkylaromatic diisocyanate with a polyalcohol to provide an isocyanate-terminated polyurethane prepolymer. The prepolymer is then chain extended using a diamine to form urea linkages. Typically, the resulting polyurethane resin has a number average molecular weight of from 10000 to 100000 Daltons, preferably from 20000 to 60000.

Any diisocyanate of the formula:

OCN—Z—NCO

wherein Z is an aliphatic, cycloaliphatic, aromatic, or alkylaromatic group can be reacted with a polyalcohol such as a polyether diol, a polyester diol, or combinations thereof to prepare the isocyanate-terminated polyurethane prepolymer. Examples of diisocyanates include, but are not limited to, 1,4-diisocyanatobutane, 1,6-diisocyanatohexane, 1,5-diisocyanato-2,2-dimethylpentane, 2,2,4- or 2,4,4-trimethyl-1,6-diisocyanatohexane, 1,10-diisocyanatodecane, 1,3- and 1,4-diiso-cyanatocyclo-hexane, 1-isocyanato-5-isocyanatomethyl-3,3,5-trimethylcyclohexane (isophorone diisocyanate), 2,3-, 2,4- and 2,6-diisocyanato-1-methylcyclohexane, 4,4′- and 2,4′-diisocyanatodicyclohexylmethane, 1-isocyanato-3(4)-isocyanatomethyl-1-methyl-cyclohexane, 2,4-, and 2,5- and 2,6-tolylene diisocyanate, 1,3® and 1,4-phenylene diisocyanate, 4,4′- and 2,4′-diisocyanatodiphenylmethane, 1,3-bis(1-isocyanato-1-methylethyl)benzene, dimer diisocyanate and mixtures thereof. Preferred is dicyclohexylmethane diisocyanate.

Suitable polyalcohols include one or more polyether diols, one or more polyester diols, and mixtures thereof.

Suitable polyether diols include those represented by the formula:

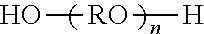

wherein R is an alkylene group with 2 to 8 carbon atoms which may be linear or branched. Preferably, R is a C₂ to C₄ alkylene group. Examples of particularly useful polyether diols include, but are not limited to, poly (ethylene ether) glycols, poly (propylene) ether glycols and poly (tetramethylene ether) glycols, with poly (tetramethylene ether) glycols being preferred. Particularly preferred is a mixture of polytetramethylene glycol and polypropylene glycol in a ratio of 50:50. The number average molecular weight of the polyether diol typically ranges from 250 to 10000, preferably from 1000 to 2500, and more preferably from 1250 to 2000. The polyether diols can also contain a minor percentage by weight, e.g., up to 40 weight percent, of ester units. These diols can be obtained, e.g., by reacting one or more of the aforesaid polyether diols with a lactone such as ε-caprolactone.

Useful polyester diols include those represented by the formula:

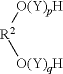

wherein
R² the residue of a diol HOR²OH, wherein R² is an alkylene group with 2 to 8 carbon atoms which may be linear or branched
Y is —OCR³COOR²⁰ in which R² has the aforestated meaning and R³ is the residue of a dicarboxylic acid HOOCR³COOH or anhydride (I) thereof, wherein R³ is an alkylene group with 2 to 8 carbon atoms which may be linear or branched and p and q independently is from 0 to 600 and preferably from 1 to 100, the sum of p+q being from 1 to 1200 and preferably from 1 to 250, or Y is —OCR⁴O— in which R⁴ is the residue of a lactone (II) or an α,ω-hydroxycarboxylic acid HOR⁴COOH and p, q and the sum of p+q have the aforestated values. Diols HOR²OH, carboxylic acids HOOCR³COOH, anhydrides (I), lactones (II) and α,ω-hydroxycarboxylic acids HOR⁴COOH that can be used herein include any of those known for preparing polyester diols. Suitable diols include ethylene glycol, propylene glycol, 1,4-butane diol, neopentyl diol, hexanediol, diethylene glycol, dipropylene glycol, and the like. Suitable dicarboxylic acids and anhydrides include adipic acid, phthalic acid, phthalic anhydride, and the like. Suitable lactones and α,ω-hydroxycarboxylic acids include butyrolactone, caprolactone, α,ω-hydroxycaproic acid and the like. Examples of particularly useful polyester diols include, but are not limited to, poly(caprolactone) diols, poly(diethylene glycol-co-ortho-phthalic acid), poly(1,6 hexanediol-co-ortho-phthalic acid), poly(neopentyl glycol-co-adipatic acid), and poly(ethylene glycol-co-adipic acid). The number average molecular weight of the polyester diol typically ranges from 250 to 10000, preferably from 500 to 2500, and more preferably from 1000 to 2000. The polyester diols can also contain ether units. In a preferred embodiment the polyester diols contain ether units in an amount of up to 40% (percentage by weight). These diols can be obtained, e.g., by reacting one or more of the aforesaid polyester diols with one or more 1,2-alkylene oxides such as ethylene oxide, propylene oxide, etc.

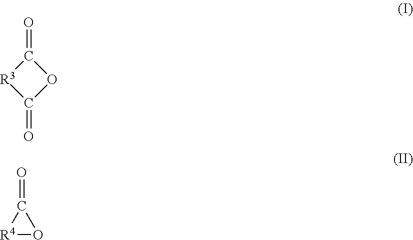

Polyether diols are desirable in terms of the product polyurethane resin having greater solubility in aliphatic alcohol solvents compared with polyester diols. However, polyester diols impart greater tensile strength to the resin. Therefore, depending on the choice of polymeric diol, the polyurethane resin obtained in accordance with the invention can vary from those resins possessing high solubility and relatively low tensile strength, i.e., those made entirely from polyether diol to those of relatively low solubility and relatively high tensile strength made entirely from polyester diol, and all of the combinations of solubility and tensile strength properties in between as would be the case where mixtures of polyether and polyester diols are employed. Optimum proportion of solubility and strength can be obtained through routine testing.

The polyalcohol and diisocyanate are reacted under conditions which are well known to those skilled in the art. Preferably, the reaction is carried out in the presence of a solvent, which is a solvent that is typically used in compositions formulated using the resin such as the solvent system of an ink formulation. Examples of suitable solvents in which the diisocyanate and polyalcohol can be reacted include, but are not limited to alkyl (1-5 carbon) acetates such as methyl acetate, ethyl acetate, propyl acetate, butyl acetate and pentyl acetate, with butyl acetate being particularly preferred.

The ratio of diisocyanate to polyalcohol is selected to obtain a desired molecular weight as well as a desired level of urethane and urea segments. An excess of diisocyanate is used to ensure that the prepolymer is isocyanate terminated. The equivalent ratio of diisocyanate to diol generally ranges from 1.2-5.0 to 1, preferred is a ratio of 2.0 to 1.

The total amount of solvent used for preparation of the isocyanate-terminated prepolymer typically ranges from 0 to 95 percent by weight of the total solution, preferably ranges from 10 to 80 percent by weight of the total solution, and more preferably ranges from 20 to 40 percent by weight of the total solution.

Formation of the isocyanate-terminated prepolymer is generally carried out at a temperature ranging from 0 to 130° C., preferably ranging from 50 to 90° C. The time of the reaction generally ranges from a period of from 1 to 12 hours, preferably from 2 to 4 hours.

The isocyanate-terminated prepolymer is then chain extended with a diamine to form a polyurethane resin. The diamine can be any aliphatic, cycloaliphatic, aromatic, or heterocyclic diamine in which each of the amine groups possesses at least one labile hydrogen atom. Among the many suitable diamines are ethylene diamine, 1,2-diaminopropane, 1,3-diaminopropane, hydrazine, diaminobutane, hexamethylene diamine, 1,4-diaminocyclohexane, 3-aminomethyl-3,5,5-trimethylcyclohexylamine (isophorone diamine), 1,3-bis(aminomethyl)cyclohexane, 1,3-bis(aminomethyl)benzene, 2-(aminomethyl)-3,3,5-trimethylcyclopentylamine, bis-(4-aminocyclo-hexyl)-methane, bis-(4-amino-3-methylcyclohexyl)-methane, 1-amino-1-methyl-3(4)-aminomethyl-cyclohexane, bis-(4-amino-3,5-diethylcyclohexyl)-methane, bis-amino-methyl-hexahydro-4,7-methanoindane, 2,3-, 2,4- and 2,6-diamino-1-methyl-cyclohexane, dimer diamine (diamine from dimerized fatty acids), norbornane diamine, 2,2,4- and 2,4,4-trimethyl-1,6-hexanediamine, DuPont brand Dytek™ A and Dytek™ EB, Huntsman's Jeffamine™ brand bis(propylamino) polypropylene oxide diamines, bis(aminomethyl)tricyclodecane, piperazine, 1,3-di-piperidylpropane, aminoethylpiperazine. Isophorone diamine is preferred.

The conditions under which the diamine is reacted with the prepolymer are not critical and are within the purview of one skilled in the art. Preferably, the reaction is carried out in the solvent or in a component of the solvent system ultimately used in the final composition formulated from the ink resin as described. The amount of solvent utilized in the chain extension reaction generally ranges from 0 to 90 percent by weight, and preferably from 35 to 60 percent by weight. The ratio of isocyanate end groups of the prepolymer to amines from the diamine determines the final polymer molecular weight of the resin as well as the level of urea groups. Generally the mole ratio of diisocyanate to diamine is from 6:1 to 1:5, preferably from 4:1 to 1:4. Typically, when the prepolymer is reacted with a stoichiometric excess of the diamine, no residual unreacted isocyanate groups remain in the prepolymer. Accordingly, reaction of the chain-extended prepolymer with an amine or alcohol terminating agent to endcap unreacted isocyanate groups on the chain-extended prepolymer is not required. Alternatively, if less than a stoichiometric excess of diamine is utilized, unreacted isocyanate groups may be present which can be endcapped as described below. The chain extension reaction with diamine is generally carried out at a temperature ranging from 0 to 90° C., and preferably ranging from 25 to 75° C.

Following the chain extension reaction with diamine, if unreacted isocyanate groups exist some or all of the remaining isocyanate groups are preferably endcapped with an amine or alcohol to terminate the foregoing poly(urethane-urea) resin. Examples of suitable amines are monoamines and diamines including, but not limited to butylamine, dibutylamine, aminopropylmorpholine, aminoethylpiperazine, dimethylaminopropylamine, di(isopropanol)amine, aminoethoxyethanol, aminoundecanoic acid, ethanolamine, dimethanolamine, 4-aminophenol, isophoronediamine, dimer diamine, oleyl amine, hydrazine, Jeffamine brand mono or bis(aminopropyl) polypropyleneoxides. Examples of suitable alcohols include, but are not limited to, 1-propanol, 2-propanol, 1-butanol, 2-butanol, neopentyl alcohol, ethanol, oleyl alcohol, 12-hydroxystearic acid, N-(hydroxyethyl)stearamide, ethoxylated nonylphenol, propoxylated nonylphenol, glycolic acid, or 6-hydroxycaproic acid.

The endcapping reaction of any remaining free isocyanate groups is carried out under conditions which are well known to those skilled in the art. Preferably, this reaction is carried out in the presence of a solvent or in a component of the solvent system ultimately used in the final composition formulated from the ink resin as described above. The total amount of solvent utilized to endcap the free isocyanate groups generally ranges from 0 to 90 percent by weight, preferably ranges from 25 to 75 percent by weight.

The temperature of the endcapping reaction generally ranges from 0 to 100° C., and preferably ranges from 25 to 75° C. The time of the endcapping reaction generally ranges from a period of from 0.1 to 6 hours, and preferably from 0.25 to 1 hours. The NCO-equivalent ratio of the chain-extended resin to amine or alcohol generally ranges from 5:1 to 1:5, and preferably ranges from 1:2 to 2:1.

The polyurethane resins of the present invention advantageously maintain at least the high laminate bond strengths before and after laminates, printed with the ink compositions containing the polyurethane resins, are subjected to sterilization.

By the polyurethane resins maintaining at least the high lamination bond strength before and after retort, a laminate printed with an ink composition containing the polyurethane resin as a binder advantageously maintains its printed image and structural integrity, i.e., the laminate remains substantially free of delamination-related defects.

The term “high lamination bond strength” shall be understood to encompass those polyurethane resins exhibiting lamination bond strength of greater than 0.5 N/15 mm peeled at 300 mm/min. In a preferred embodiment the lamination bond strength is at least 1.2 N/15 mm peeled at 300 mm/min

The laminating ink composition of the invention comprises the polyurethane resin of the invention; a colorant; and an organic solvent. The ink composition of the invention may be used in either flexo or gravure printing. In particular, the ink of the invention comprises, based on the weight of the ink: 10 wt. % to 50 wt. % of the polyurethane resin, 6 wt. % to 50 wt. % of the colorant and 10 wt. % to 80 wt. % of the organic solvent, where component concentrations may be adjusted for use in flexo or gravure printing. Preferably, the gravure ink comprises 8 wt. % to 60 wt. % of the polyurethane resin, 3 wt. % to 30 wt. % of the colorant and 10 wt. % to 80 wt. % of the organic solvent such as alkyl ester solvent; and the flexo ink comprises, 8 wt. % to 60 wt. % of the polyurethane resin, 3 wt. % to 50 wt. % of the colorant and 10 wt. % to 80 wt. % of the organic solvent such as an alcohol solvent. The ink suitably has a viscosity between 15 seconds to 30 seconds, as measured in a Zahn 2 efflux cup. Efflux cup measurements are conventional methods for measuring ink viscosities, and involve timing the flow of a calibrated quantity of ink through a calibrated orifice. The lower viscosity inks typically are used in gravure printing and the higher viscosity inks typically are used in flexo printing. Thus, when the ink has a viscosity of 28 seconds as measured in a Zahn 2 efflux cup, it is suitable for flexo printing; and when the ink has a viscosity of 18 seconds as measured in a Zahn 2 efflux cup, it is suitable for gravure printing applications.

Another aspect of the invention relates to the printing of the laminating ink image wise onto a surface of a polymeric substrate and forming a dried ink image on a surface of the substrate, which image is tack-free, firmly adherent to the surface of the substrate, and unblocked when contacted under pressure at ambient temperatures to a second surface of the same or another substrate. Although any polymeric substrate may be printed with this method, preferred polymeric substrates include polyethylene (PE), polypropylene (PP), polyethylene terephthalate (PET), cellulose acetate, cellulose acetate butyrate, polycarbonate (PC), polyamide (PA), PVDC coated polyethylene terephthalate, PVDC coated polypropylene, metallized polyethylene terephthalate, or metallized polypropylene. Particularly preferred film substrates used for lamination are PET, PP, PA, silicon dioxide coated PET, PA and PP and aluminum oxide coated PET, PA and PP films.

A second substrate or even more may be laminated to the dried ink image on the first substrate by any conventional method to form a printed laminate. Thus, the second substrate may be applied as an extruded melt onto the dried image to form the second substrate; alternatively, a preformed second substrate or a combination of films may be laminated to the dried ink image through an adhesive surface. The second substrate or a combination of films may be composed of the same material as the first substrate or it may be different depending on the nature of the end use of the printed laminate.

In general, at least one of the substrates will be translucent to visible light and, more typically, transparent. Such transparency or translucency will allow colorant to present a hue and/or resolvable image through the substrate.

An additional embodiment of the present invention further comprises subjecting the printed laminate to sterilization conditions to form a sterilized laminate, wherein the ink image remains substantially unchanged and wherein the sterilized laminate is free of delamination defects. In this embodiment, the printed laminate can be a packaging material for contents (e.g., such as foods, medicines and the like) which are processed in situ at elevated temperatures by sterilization. A typical sterilization operation commonly used in the food packaging industry involves water steam at 121° C./30 minutes/1.03 bar saturated water steam pressure.

The sterilized laminate advantageously maintains the properties described above after being subjected to sterilization due to the presence of the polyurethane resin of the invention in the printing ink composition used to form the printed image.

The following Examples are illustrative of the present invention and should not be construed in any manner whatsoever as limiting of the scope of the invention.

### EXAMPLES

### 1. Test Methods

### US Units and SI

US units and SI units can be interconverted as follows:

### 250° F.=121.1° C.

### 175° F.=79.4 C

1 g/inch=0.005791 N/15 mm
1 psi=0.0689475728 bar
1 lb/ream=1.631 g/m²

### Printing

A 165P hand proofer from Pamarco was used in printing inks onto the films.

### Tape Adhesion

The tape Scotch® 610 from 3M was stuck immediately after the prints were dried:

0%=poor ink adhesion with 100% ink coming off from the substrate
100%=excellent ink adhesion with 0% ink coming off from the substrate

### Block Resistance

Prints were folded to have ink/back and ink/ink contact.

Folded prints were subjected to 52° C./2.8 bar/24 h (which corresponds to 125 F/40 psi/24 h) in an oven.

1=poor block resistance with 100% ink transfer from the print side
10=excellent block resistance with 0% ink transfer from the print side

### Adhesive Lamination

Laminate structure (example): film/ink/adhesive/film
Dry adhesive film thickness: 3.3-4.9 g/m² (corresponds to 2-3 lb/ream)
Lamination condition: 79° C./1.438 bar/1 sec (corresponds to 175 F/20 psi/1 sec) using a CARD/GUARD® laminator from Jackson-Hirsh Laminating.

Adhesives were applied on the printed film. The coating weight and cure conditions were followed according to the adhesive manufacturer's recommendations. For the solvent-based adhesive Adcote® 812/Adcote® 811B, a coating weight of at 3.3-4.9 g/m² dry (corresponds to 2-3 lb/ream) was applied and the laminates were cured at 52° C. for 3 days. For the solvent-based adhesive Liofol® UR 3644/Hardener UR 6055, a coating weight of 3.3-4.9 g/m² dry (corresponds to 2-3 lb/ream) was applied and the laminates were cured at room temperature for 3 days.

### Sterilization Conditions

After the laminates were cured they were subjected to water steam sterilization at 121° C./30 minutes/1.03 bar saturated water steam pressure (corresponds to 250 F/15 psi/30 min) in an All American Electric Pressure Steam Sterilizer. Bond strengths of the laminates were measured before and immediately after sterilization.

### Bond Strength Test

Thwing Albert Friction/Peel tester Model 225-1, prints were supported with tape, peeled at 180° C. with 300 mm/min speed, values are average of 3 readings in N/15 mm.

Destruct: complete film tear during peel
FT: partial film tear during peel
Decal: 100%=all ink coming off from the printed film during peel
0%=no ink coming off from the printed film during peel

### 2. Raw Materials

Desmodur W® from Bayer
Pluriol P 2000® from BASF
Poly THF 2000® from BASF
BiCat 8® from Shepherd Chemical
Pluracol 2010® from BASF
BiCat-8® from Shepherd Chemical
Versamid PUR 1120® from Cognis
Mondur ML® from Bayer
Blue 15:4=Lionol Blue FG 7400 G pigment from Toyo
TR 52=Titanium dioxide pigment from Huntsman
RDE 2=Titanium dioxide pigment from Kemira
T523-3=15 μm corona pre-treated boPP film from AET Films
Mylar® 813=12 μm corona pre-treated PET from DuPont
Techbarrier® NR=15 μm SiO_{X} coated oPA film (not corona treated) from Mitsubishi Plastics
Techbarrier® TZ=12 μm SiO_{X} coated PET film (not corona treated) from Mitsubishi Plastics
Emblem® 1500=15 μm corona pre-treated boPA film from Honeywell
Tredegar® CPP=76 μm corona pre-treated white, opaque cPP film from Tredegar
50 μm corona pre-treated white, opaque PE film from Southern Converter
26 μm aluminium foil from Reynolds
Adcote® 812/Adcote® 811B=2-component polyurethane adhesive from Rohm & Haas Liofol® UR 3644/Hardener UR 6055=2-component polyurethane adhesive from Henkel
PVB blue ink=SFP Blue from Siegwerk
PVB white ink=HP 930 White from Siegwerk

### Polyurethane Examples

### Example Resin 1

6.65% Desmodur™ W, 12.64% Pluriol™ P 2000 and 12.64% Poly THF™ 2000 were reacted using 0.02% BiCAT™ 8 as catalyst and 8.75% butylacetate as solvent at 80-85° C. for 2 hrs under nitrogen flow until NCO % of 2.60 was achieved. This resulted in an isocyanate terminated prepolymer with 78.50% solids and a viscosity of 2220 cps at 25° C.

The final polyurethane resin solution was prepared by adding the above prepolymer solution at a controlled rate to 2.72% of isophorone diamine in 45.51% 1-propanol and 11.06% butylacetate.

The final polyurethane solution had a viscosity of 580 cps at 25° C., solids of 36.5% and Gardner color of less than 2.

### Example Resin 2

6.76% Desmodur™ W, 25.90% PolyTHFT™ 2000 were reacted using 0.02% BiCAT™ 8 as catalyst and 8.95% butylacetate as solvent at 80-85° C. for 2 hrs under nitrogen flow until NCO % of 2.60 was achieved. This resulted in an isocyanate terminated prepolymer with 81.8% solids and a viscosity of 14,000 cps at 25° C.

The final polyurethane resin solution was prepared by adding the above prepolymer solution at a controlled rate to 2.75% of isophorone diamine in 45.91% 1-propanol and 9.72% butylacetate.

The final polyurethane solution had a viscosity of 6060 cps at 25° C., solids of 35.80% and Gardner color of less than 2.

### Example Resin 3

6.47% Mondur™ ML, 13.10% Plurocol™ 2010 and 13.10% Poly THF™2000 were reacted using 0.02% BiCAT™ 8 as catalyst and 8.95% butylacetate as solvent at 80-85° C. for 2 hrs under nitrogen flow until NCO % of 2.60 was achieved. This resulted in an isocyanate terminated prepolymer with 80.50% solids and a viscosity of 3670 cps at 25° C.

The final polyurethane resin solution was prepared by adding the above prepolymer solution at a controlled rate to 2.71% of isophorone diamine in 45.93% 1-propanol and 9.73% butylacetate.

The final polyurethane solution had a viscosity of 3990 cps at 25° C., solids of 35.3% and Gardner color of less than 2.

### Example Resin 4

6.48% Mondur™ ML, 26.20% Plurocol™ 2010 reacted using 0.02% BiCAT™ 8 as catalyst and 8.95% butylacetate as solvent at 80-85° C. for 2 hrs under nitrogen flow until NCO % of 2.60 was achieved. This resulted in an isocyanate terminated prepolymer with 79.70% solids and a viscosity of 926 cps at 25° C.

The final polyurethane resin solution was prepared by adding the above prepolymer solution at a controlled rate to 2.67% of isophorone diamine in 45.94% 1-propanol and 9.73% butylacetate.

The final polyurethane solution had a viscosity of 696 cps at 25° C., solids of 32.7% and the solution was turbid.

### Example Resin 5

6.76% Desmodur™ W, 25.88% Plurocol™ 2010 reacted using 0.02% BiCAT™ 8 as catalyst and 8.94% butylacetate as solvent at 80-85° C. for 2 hrs under nitrogen flow until NCO % of 2.60 was achieved. This resulted in an isocyanate terminated prepolymer with 81.70% solids and a viscosity of 828 cps at 25° C.

The final polyurethane resin solution was prepared by adding the above prepolymer solution at a controlled rate to 2.78% of isophorone diamine in 45.89% 1-propanol and 9.72% butylacetate.

The final polyurethane solution had a viscosity of 367 cps at 25° C., solids of 40.0% and Gardner color of less than 2.

| Ink formula | Example ink 1 | Example ink 2 | Example ink 3 | Example ink 4 | Example ink 5 |
|---|---|---|---|---|---|
| Example resin 1 (g) | 35.8 | | | | |
| Example resin 2 (g) | | 36.3 | | | |
| Example resin 3 (g) | | | 36.8 | | |
| Example resin 4 (g) | | | | 39.8 | |
| Example resin 5 (g) | | | | | 32.5 |
| Blue 15:4 (g) | 17.0 | 17.0 | 17.0 | 17.0 | 17.0 |
| 1-propanol/butyl acetate 8:2 (g) | 47.2 | 46.7 | 46.2 | 43.2 | 50.5 |
| Total (g) | 100.0 | 100.0 | 100.0 | 100.0 | 100.0 |
| Glass beads (g) | 30 | 30 | 30 | 30 | 30 |
| Total solids (%) | 30 | 30 | 30 | 30 | 30 |
| Grinding time (min) | 30 | 30 | 30 | 30 | 30 |
| Pigment:binder ratio | 1.3:1.0 | 1.3:1.0 | 1.3:1.0 | 1.3:1.0 | 1.3:1.0 |
| Initial viscosity (Zahn 2 cup, sec) | 33 | 92 | 80 | 37 | 21 |
| % dilution with 1-propanol | 10 | 20 | 20 | 12 | 0 |
| to 25 sec (Zahn 2 cup) | | | | | |

### Performance Examples

### Performance Example 1

Laminate structure: boPP or PET/ink/Adcote ® 812/Adcote ® 811B/
Emblem ® 1500/Adcote ® 812/Adcote ® 811B/2 mil PE

| | Example Ink 1 | Example Ink 2 | Example Ink 3 | Example Ink 4 | Example Ink 5 |
|---|---|---|---|---|---|
| T523-3 boPP film | | | | | |
| Lamination bond | destruct | destruct | destruct | destruct | 2.9 (FT) |
| strength (with tape) | | | | | |
| before sterilization | | | | | |
| Decal | | | | | 50% |
| Lamination bond | destruct | destruct | 3.0 (FT) | 3.2 (FT) | 1.9 |
| strength (with tape) | | | | | |
| after sterilization | | | | | |
| Decal | | | 10% | 10% | 100% |
| Mylar ® 813 PET | | | | | |
| Lamination bond | destruct | destruct | 2.9 | 2.1 | 1.7 |
| strength (with tape) | | | | | |
| before sterilization | | | | | |
| Decal | | | 70% | 70% | 90% |
| Lamination bond | destruct | destruct | 2.5 | destruct | 0.04 |
| strength (with tape) | | | | | |
| after sterilization | | | | | |
| Decal | | | 50% | | 70% |

Example resin 1 comparison with a commercial PVB ink.

| | White | Blue |
|---|---|---|
| | ink formula | ink formula |
| | Example ink 1 | Example ink 1 |
| Example resin 1 (g) | 30.00 | 39.56 |
| TR 52/RDE 2 1:1 (g) | 42.00 | |
| Blue 15:4 (g) | | 18.00 |
| 1-propanol/1-propyl acetate 8:2 (g) | 28.00 | 42.44 |
| Total (g) | 100.00 | 100.00 |
| Glass beads (g) | 30.00 | 30.00 |
| Grinding time (min) | 60 | 60 |
| Initial viscosity (Zahn 2 cup, sec) | 53 | 30 |
| Solids (%) | 52.50 | 31.85 |
| Pigment:binder ratio | 4.00 | 1.30 |

| | White ink formulas | | Blue ink formulas | |
|---|---|---|---|---|
| | | Example | | Example |
| Flow behavior | PVB ink | Ink 1 | PVB ink | Ink 1 |
| % dilution with | | 15 | | 7 |
| ethanol/ethyl acetate | | | | |
| 80:20 to 25 sec | | | | |
| (Zahn 2 cup) | | | | |
| % dilution with | 13 | | 4 | |
| ethanol/propyl acetate | | | | |
| 80:20 to 25 sec | | | | |
| (Zahn 2 cup) | | | | |
| Ink solids (%) | 40 | 45.9 | 27 | 28.1 |

### Performance Example 2

Laminate structure: Mylar ® 813/ink/adhesive/Techbarrier ® NR/adhesive/Tredegar ® CPP

| | White inks with | | White inks with | |
|---|---|---|---|---|
| | Adcote 812-811B | | Liofol UK 3644-UK 6055 | |
| | PVB ink | Example ink 1 | PVB ink | Example ink 1 |
| Tape adhesion | 95% | 100% | 95% | 100% |
| Block resistance | 8 | 10 | 8 | 10 |
| Lamination bond | destruct | 1.2 | 2.4 (FT) | 1.0 |
| strength (with tape) | | | | |
| before sterilization | | | | |
| Decal | | 90% | 0% | 85% |
| Lamination bond | 5.0 | 1.1 | Destruct | 0.8 |
| strength (with tape) | | | | |
| after sterilization | | | | |
| Decal | 50% | 90% | | 90% |

| | Blue ink with | | Blue ink with Liofol ® UR | |
|---|---|---|---|---|
| | Adcote ® 812/Adcote ® 811B | | 3644/Hardener UR 6055 | |
| | PVB ink | Example ink 1 | PVB ink | Example ink 1 |
| Tape adhesion | 100% | 100% | 100% | 100% |
| Block resistance | 10 | 9 | 10 | 9 |
| Lamination bond | 2.6 | destruct | 0.8 | destruct |
| strength (with tape) | | | | |
| before sterilization | | | | |
| Decal | 5% | | 0% | |
| Lamination bond | 2.0 | destruct | destruct | 2.6 |
| strength (with tape) | | | | |
| after sterilization | | | | |
| Decal | 0% | | | 40% |

| | White over blue inks with | | White over blue inks with Liofol ® | |
|---|---|---|---|---|
| | Adcote ® 812/Adcote ® 811B | | UR 3644/Hardener UR 6055 | |
| | PVB ink | Example ink 1 | PVB ink | Example ink 1 |
| Tape adhesion | 100% | 100% | 100% | 100% |
| Block resistance | 8 | 9 | 8 | 9 |
| Lamination bond | 1.9 | destruct | 0.8 | destruct |
| strength (with tape) | | | | |
| before sterilization | | | | |
| Decal | 85% | | 0% | |
| Lamination bond | 1.3 | 3.3 (FT) | destruct | 2.3 |
| strength (with tape) | | | | |
| after sterilization | | | | |
| Decal | 80% | 70% | | 90% |

### Performance Example 3

Laminate structure: Mylar ® 813/ink/adhesive/aluminum foil/adhesive/Tredegar ® CPP

| | White inks with | | White inks with | |
|---|---|---|---|---|
| | Adcote ® 812/Adcote ® 811B | | Liofol ® UR 3644/Hardener UR 6055 | |
| | PVB ink | Example ink 1 | PVB ink | Example ink 1 |
| Tape adhesion | 95% | 100% | 95% | 100% |
| Block resistance | 8 | 10 | 8 | 10 |
| Lamination bond | 3.7 (FT) | 1.3 | destruct | 1.7 |
| strength (with tape) | | | | |
| before sterilization | | | | |
| Decal | 95% | 90% | | 90% |
| Lamination bond | destruct | 1.0 | destruct | 1.4 |
| strength (with tape) | | | | |
| after sterilization | | | | |
| Decal | | 95% | | 95% |

| | Blue inks with | | Blue inks with Liofol ® | |
|---|---|---|---|---|
| | Adcote ® 812/Adcote ® 811B | | UR 3644/Hardener UR 6055 | |
| | PVB ink | Example ink 1 | PVB ink | Example ink 1 |
| Tape adhesion | 100% | 100% | 100% | 100% |
| Block resistance | 10 | 9 | 10 | 9 |
| Lamination bond | 3.9 (FT) | destruct | 3.7 | destruct |
| strength (with tape) | | | | |
| before sterilization | | | | |
| Decal | 5% | | 5% | |
| Lamination bond | destruct | destruct | destruct | destruct |
| strength (with tape) | | | | |
| after sterilization | | | | |
| Decal | | | | |

| | White over blue inks with | | White over blue inks with Liofol ® | |
|---|---|---|---|---|
| | Adcote ® 812/Adcote ® 811B | | UR 3644/Hardener UR 6055 | |
| | PVB ink | Example ink 1 | PVB ink | Example ink 1 |
| Tape adhesion | 100% | 100% | 100% | 100% |
| Block resistance | 8 | 9 | 8 | 9 |
| Lamination bond | destruct | destruct | 4.1 (FT) | destruct |
| strength (with tape) | | | | |
| before sterilization | | | | |
| Decal | | | 60% | |
| Lamination bond | 2.1 | destruct | destruct | destruct |
| strength (with tape) | | | | |
| after sterilization | | | | |
| Decal | 70% | | | |

### Performance Example 4

Laminate structure: Techbarrier ® TZ/ink/adhesive/Tredegar ® CPP

| | White inks with | | White inks with Liofol ® | |
|---|---|---|---|---|
| | Adcote ® 812/Adcote ® 811B | | UR 3644/Hardener UR 6055 | |
| | PVB ink | Example ink 1 | PVB ink | Example ink 1 |
| Tape adhesion | 100% | 100% | 100% | 100% |
| Block resistance | 10 | 10 | 10 | 10 |
| Lamination bond | 2.1 | destruct | 1.7 | 0.5 |
| strength (with tape) | | | | |
| before sterilization | | | | |
| Decal | 95% | | 95% | 90% |
| Lamination bond | destruct | destruct | destruct | destruct |
| strength (with tape) | | | | |
| after sterilization | | | | |
| Decal | | | | |

| | Blue inks with | | Blue inks with | |
|---|---|---|---|---|
| | Adcote ® 812/Adcote ® 811B | | Liofol ® UR 3644/Hardener UR 6055 | |
| | PVB ink | Example ink 1 | PVB ink | Example ink 1 |
| Tape adhesion | 100% | 95% | 100% | 95% |
| Block resistance | 10 | 8 | 10 | 8 |
| Lamination bond | destruct | destruct | 1.4 | 2.2 |
| strength (with tape) | | | | |
| before sterilization | | | | |
| Decal | | | 5% | 95% |
| Lamination bond | destruct | destruct | destruct | destruct |
| strength (with tape) | | | | |
| after sterilization | | | | |
| Decal | 5% | | | |

| | White over blue inks with | | White over blue inks with Liofol ® | |
|---|---|---|---|---|
| | Adcote ® 812/Adcote ® 811B | | UR 3644/Hardener UR 6055 | |
| | PVB ink | Example ink 1 | PVB ink | Example ink 1 |
| Tape adhesion | 100% | 100% | 100% | 100% |
| Block resistance | 8 | 10 | 8 | 10 |
| Lamination bond | destruct | destruct | destruct | 1.9 |
| strength (with tape) | | | | |
| before sterilization | | | | |
| Decal | | | | 90% |
| Lamination bond | 2.7 | destruct | destruct | destruct |
| strength (with tape) | | | | |
| after sterilization | | | | |
| Decal | 85% | | | |

### Performance Example 5

Laminate structure: Emblem ® 1500/ink/adhesive/Tredegar ® CPP

| | White inks with | | White inks with | |
|---|---|---|---|---|
| | Adcote ® 812/Adcote ® 811B | | Liofol ® UR 3644/Hardener UR 6055 | |
| | PVB ink | Example ink 1 | PVB ink | Example ink 1 |
| Tape adhesion | 100% | 100% | 100% | 100% |
| Block resistance | 9 | 10 | 9 | 10 |
| Lamination bond | destruct | 2.6 (FT) | 1.8 | 1.8 |
| strength (with tape) | | | | |
| before sterilization | | | | |
| Decal | | 90% | 90% | 95% |
| Lamination bond | 3.3 | 1.4 | 3.4 | 1.5 |
| strength (with tape) | | | | |
| after sterilization | | | | |
| Decal | 90% | 95% | 90% | 95% |

| | Blue inks with | | Blue inks with Liofol ® | |
|---|---|---|---|---|
| | Adcote ® 812/Adcote ® 811B | | UR 3644/Hardener UR 6055 | |
| | PVB ink | Example ink 1 | PVB ink | Example ink 1 |
| Tape adhesion | 100% | 100% | 100% | 100% |
| Block resistance | 9 | 8 | 9 | 8 |
| Lamination bond | 1.9 | destruct | 2.2 | destruct |
| strength (with tape) | | | | |
| before sterilization | | | | |
| Decal | 80% | | 10% | |
| Lamination bond | 2.8 | destruct | 2.4 | destruct |
| strength (with tape) | | | | |
| after sterilization | | | | |
| Decal | 40% | | 65% | |

| | White over blue inks with | | White over blue inks with Liofol ® | |
|---|---|---|---|---|
| | Adcote ® 812/Adcote ® 811B | | UR 3644/Hardener UR 6055 | |
| | PVB ink | Example ink 1 | PVB ink | Example ink 1 |
| Tape adhesion | 100% | 100% | 100% | 100% |
| Block resistance | 7 | 10 | 7 | 10 |
| Lamination bond | 1.6 | destruct | 1.4 | destruct |
| strength (with tape) | | | | |
| before sterilization | | | | |
| Decal | 85% | 10% | 90% | |
| Lamination bond | 2.2 | destruct | 2.4 | destruct |
| strength (with tape) | | | | |
| after sterilization | | | | |
| Decal | 85% | | 85% | |

### Performance Example 6

Laminate structure: Techbarrier ® NR/ink/adhesive/Tredegar ® CPP

| | White inks with | | White inks with | |
|---|---|---|---|---|
| | Adcote ® 812/Adcote ® 811B | | Liofol ® UR 3644/Hardener UR 6055 | |
| | PVB ink | Example ink 1 | PVB ink | Example ink 1 |
| Tape adhesion | 100% | 100% | 100% | 100% |
| Block resistance | 8 | 10 | 8 | 10 |
| Lamintion bond | 5.0 | 2.8 | 2.3 | 0.6 |
| strength (with tape) | | | | |
| before sterilization | | | | |
| Decal | 85% | 85% | 95% | 90% |
| Lamination bond | 1.8 | destruct | 3.4 | 5.8 |
| strength (with tape) | | | | |
| after sterilization | | | | |
| Decal | 95% | | 90% | 95% |

| | Blue inks with | | Blue inks with Liofol ® | |
|---|---|---|---|---|
| | Adcote ® 812/Adcote ® 811B | | UR 3644/Hardener UR 6055 | |
| | PVB ink | Example ink 1 | PVB ink | Example ink 1 |
| Tape adhesion | 90% | 95% | 90% | 95% |
| Block resistance | 7 | 8 | 7 | 8 |
| Lamination bond | 3.7 | 8.3 | 2.3 | 2.8 |
| strength (with tape) | | | | |
| before sterilization | | | | |
| Decal | 20% | 50% | 35% | 95% |
| Lam bond strength | 4.1 | 7.7 | 1.9 | 8.9 |
| (with tape) after retort | | | | |
| condition | | | | |
| Decal | 10% | 35% | 80% | 5% |

| | White over blue inks with | | White over blue inks with Liofol ® | |
|---|---|---|---|---|
| | Adcote ® 812/Adcote ® 811B | | UR 3644/Hardener UR 6055 | |
| | PVB ink | Example ink 1 | PVB ink | Example ink 1 |
| Tape adhesion | 100% | 100% | 100% | 100% |
| Block resistance | 7 | 9 | 7 | 9 |
| Lamination bond | 1.3 | 5.8 | 1.8 | 2.2 |
| strength (with tape) | | | | |
| before sterilization | | | | |
| Decal | 85% | 65% | 90% | 95% |
| Lamination bond | 2.2 | 6.4 | 2.7 | 7.1 |
| strength (with tape) | | | | |
| after sterilization | | | | |
| Decal | 90% | 60% | 85% | 70% |

As can be seen from the bond strength data above for six laminate structure Performance Examples of the invention, the lamination bond strength of the polyurethane, before and after sterilization, remained above at least 0.5 N/15 mm, thus providing a laminate substantially free of delamination defects while also maintaining the integrity of the printed image.

What is claimed is:

1-24. (canceled)

25. A method of preparing a laminating ink for laminated packaging applications, comprising adding to an ink base, a binder composition comprising a polyurethane resin prepared by the steps comprising:
(a) reacting a diisocyanate and a polyalcohol to form an isocyanate-terminated prepolymer, and
(b) extending said prepolymer by reacting with a diamine to form the polyurethane resin,
wherein said polyurethane resin has at least the same lamination bond strength before and after sterilization, provided that if sterilization is done under the conditions of about 121° C./30 minutes/1.03 bar saturated water steam pressure, then the lamination bond strength of the polyurethane before and after sterilization is at least 0.5 N/15 mm when peeled at 300 mm/min,
and wherein the lamination bond strength is measured with a dry ink film thickness in the range of 1 to 5 micrometers.

26. The method of claim 1 wherein said diisocyanate comprises a member selected from the group consisting of 1,4-diisocyanatobutane; 1,6-diisocyanatohexane; 1,5-diisocyanato-2,2-dimethylpentane; 2,2,4-trimethyl-1,6-diisocyanatohexane; 2,4,4-trimethyl-1,6-diisocyanatohexane; 1,10-diisocyanatodecane; 1,3-diisocyanatocyclohexane; 1,4-diisocyanatocyclo-hexane; 1-isocyanato-5-isocyanatomethyl-3,3,5-trimethylcyclohexane; 2,3-diisocyanato-1-methylcyclohexane; 2,4-diisocyanato-1-methylcyclohexane; 2,6-diisocyanato-1-methylcyclohexane; 4,4′-diisocyanatodicyclohexylmethane; 2,4′-diisocyanatodicyclohexylmethane; 1-isocyanato-3(4)-isocyanatomethyl-1-methyl-cyclohexane; 2,4-toluene diisocyanate; 2,5-toluene diisocyanate; 2,6-toluene diisocyanate; 1,3-phenylene diisocyanate; 1,4-phenylene diisocyanate; 4,4′-diisocyanatodiphenylmethane; 2,4′-diisocyanatodiphenylmethane; 1,3-bis(1-isocyanato-1-methylethyl)benzene; dimer diisocyanate; and combinations thereof.

27. The method of claim 1 wherein said diisocyanate comprises 2,4′-dicyclohexylmethane diisocyanate.

28. The method of claim 1 wherein said polyalcohol comprises a member selected from the group consisting of polyether diols, polyester diols, and combinations thereof.

29. The method of claim 28 wherein said polyether diol comprises at least one member of the formula: 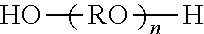
wherein R is a C₂ to C₈ straight chain or branched hydrocarbon group.

30. The method of claim 29 wherein said polyether diol comprises a mixture of polytetramethylene glycol and polypropylene glycol.

31. The method of claim 28 wherein said polyester diol comprises at least one member of the formula: 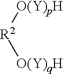
wherein R² is a linear or branched C2-C8 alkylene group; Y is OCR³COOR²⁰ in which R² is described above; R³ is a linear or branched C2-C8 alkylene group, and p and q independently are from 0 to 600, the sum of p+q being from 1 to 1200, or Y is —OCR⁴O—, in which R⁴ is the residue of a lactone or an α,ω-hydroxycarboxylic acid HOR⁴COOH.

32. The method of claim 31 wherein said polyester diol is selected from the group consisting of poly(caprolactone) diols, poly(diethylene glycol-co-ortho-phthalic acids), poly(1,6-hexanediol-co-ortho-phthalic acids), poly(neopentyl glycol-co-adipatic acids), poly(ethyleneglycol-co-adipic acids) and combinations thereof.

33. The method of claim 1 wherein said diisocyanate and polyalcohol are reacted in a ratio of 1.2-5 to 1.

34. The method of claim 1 wherein said diamine comprises a member selected from the group consisting of ethylenediamine; 1,2-diaminopropane; 1,3-diaminopropane; hydrazine; diaminobutane; hexamethylenediamine; 1,4-diaminocyclohexane; 3-aminomethyl-3,5,5-trimethylcyclohexylamine (isophorone diamine); 1,3-bis(aminomethyl)cyclohexane; 1,3-bis(aminomethyl)benzene; 2-(aminomethyl)-3,3,5-trimethylcyclopentylamine; bis-(4-aminocyclohexyl)-methane; bis-(4-amino-3-methylcyclohexyl)methane; 1-amino-1-methyl-3(4)-aminomethylcyclohexane; bis-(4-amino-3,5-diethylcyclohexyl)methane; bis-aminomethyl-hexahydro-4,7-methanoindane; 2,3-diamino-1-methylcyclohexane; 2,4-diamino-1-methylcyclohexane; 2,6-diamino-1-methylcyclohexane; dimer diamine; norbornane diamine; 2,2,4-trimethyl-1,6-hexanediamine; and 2,4,4-trimethyl-1,6-hexanediamine; bis(propylamino)polypropyleneoxide diamine; bis(aminomethyl)tricyclodecane; piperazine; 1,3-dipiperidylpropane; aminoethylpiperazine; and combinations thereof.

35. The method of claim 34 wherein said diamine comprises isophorone diamine.

36. The method of claim 1 wherein said isocyanate-terminated prepolymer and said diamine are reacted in a molar ratio of from 6:1 to 1:5.

37. A laminating ink composition for laminated packaging applications, which ink comprises:
(a) at least one polyurethane resin of claim 1;
(b) at least one colorant; and
(c) at least one organic solvent.

38. A laminate for use in packaging applications, which laminate comprises a polymeric substrate printed with the ink composition of claim 37 to form a printed image on said substrate, said printed image remaining substantially intact and said laminate having substantially the same lamination bond strength before and after sterilization.

39. The laminate of claim 38 wherein the lamination bond strength before and after sterilization is at least 0.5 N/15 mm when peeled at 300 mm/min.
